(19) United States
(12) Patent Application Publication
(10) Pub. No.: US 2011/0290796 A1
(43) Pub. Date: Dec. 1, 2011

(54) Portable Storage System

(75) Inventor: Roddy Burgess, Charlotte, NC (US)

(73) Assignee: RUBBERMAID, INCORPORATED, Huntersville, NC (US)

(21) Appl. No.: 13/114,669

(22) Filed: May 24, 2011

Related U.S. Application Data
(60) Provisional application No. 61/349,461, filed on May 28, 2010.

(51) Int. Cl. B65D 21/02; B23P 19/04; B65D 25/04

(52) U.S. Cl. 220/23.2; 220/529; 220/552; 29/428

(57) ABSTRACT

A storage system comprises a container comprising a rigid side wall defining a corner. A divider comprises a first flexible wall attached to the side wall and a second wall attached to the side wall. The first wall is connected to the second wall and is movable between a first configuration where the first wall and the second wall extend parallel to the side wall and a second configuration where the first wall and the second wall extend away from the side wall to define a first compartment in the container. The system may proved a plurality of containers sized such that they may be stacked on top of one another and nested inside of one another.

This application claims benefit of priority under 35 U.S.C. §119(e) to the filing date of to U.S. Provisional Application No. 61/349,461, as filed on May 28, 2010, which is incorporated herein by reference in its entirety.

### BACKGROUND

Storage devices such as soft-sided fabric containers, wicker and natural fiber baskets and plastic totes are known for household organization. Such storage containers may become part of the overall clutter of a home and may not in some cases be attractive or sturdy. Moreover, these storage devices either do not provide internal organization or the internal organization options that are available are permanent, inflexible and not modular to change with the user's needs. Such storage containers are also not necessarily sized appropriately for common-use items throughout the home. Large furniture storage devices are also known; however, large furniture pieces are not portable and cannot be easily moved by the user from one area of the home to another area of the home.

### SUMMARY OF THE INVENTION

A storage system comprises a container comprising a rigid side wall defining a corner. A divider comprises a first flexible wall attached to the side wall and a second wall attached to the side wall. The first wall is connected to the second wall and is movable between a first configuration where the first wall and the second wall extend parallel to the side wall and a second configuration where the first wall and the second wall extend away from the side wall to define a first compartment in the container.

The side wall may comprise a first rigid side wall, a second rigid side wall, a third rigid side wall opposite to the first side wall and a fourth rigid side wall opposite to the second side wall defining an opening. The container may have a cuboid structure. The side wall may comprise a rigid panel covered by a decorative outer covering. The rigid panel may comprise medium density fiber board (MDF). The outer cover may comprise a polyester fabric. The container may comprise a base connected to the side wall where the base comprises base footers. The base footers may be spaced from a peripheral edge of the base a distance approximately equal to the thickness of the side wall to create a rim on the base between the base footers and a peripheral edge of the base. The base footers of a first container may be inserted into an opening of a second container where the rim rests on the side wall and the base footers are disposed closely adjacent to the side wall. The first wall may have a first vertical edge connected to the first side wall and the second wall may have a second vertical edge connected to the second side wall. The length of first wall may be one half the length of the first side wall and the length of the second wall may be one half the length of the second side wall. A second vertical edge of the first wall may be connected to a second vertical edge of the second wall at a corner. The second wall may be flexible. A second divider may be used to divide the container into four separate compartments and the four compartments may be approximately of equal size. A lid may define an interior space where the lid may be placed on the container in a first orientation with the interior space facing away from the container to create a cover for items stored in the container and a shelf for retaining items on the top of the lid. The lid may be placed on the container in a second orientation with the interior space facing toward the container where the lid expands the capacity of the container.

A storage system comprises a first container comprising a first rigid side wall and a first divider comprising a first flexible resilient wall attached to the first rigid side wall and being movable between a first configuration where the first divider is spaced from the first rigid side wall to create a first storage compartment with the first rigid side wall and a second configuration where the first divider is disposed along and closely adjacent to the first rigid side wall. A second container comprises a second rigid side wall and a second divider comprising a second flexible resilient wall attached to the second side wall and being movable between a first configuration where the second divider is spaced from the second rigid side wall to create a second storage compartment with the second rigid side wall and a second configuration where the second divider is disposed along and closely adjacent to the second rigid side wall. The first container is the same size as the second container such that the first container may be supported on the side wall of the second container. A third similar container may be provided that is smaller than the second container.

A method of using a storage system comprises providing a container comprising a first side wall and a second side wall defining a first corner and a divider comprising a first flexible wall attached to the first side wall and a second wall attached to the second side wall where the first flexible wall is attached to the second flexible wall at a second corner; grasping the divider in the area adjacent the second corner; pulling the second corner away from the first corner to deform at least one of the first flexible wall and the second flexible wall; allowing the at least one of the first flexible wall and the second flexible wall to return to an undeformed state where the first flexible wall extends away from the first side wall and the second flexible wall extends away from the second side wall.

### BRIEF DESCRIPTION OF THE DRAWINGS

FIG. 1 is a perspective view of an embodiment of a container used in the storage system of the invention.

FIG. 2 is a side view of the container of FIG. 1.

FIG. 3 is a bottom view of the container of FIG. 1.

FIG. 4 is a partially cut-away view of an embodiment of the wall structure of the container.

FIG. 5 is a perspective view of the container showing the dividers in a deployed position.

FIG. 6 is a perspective view of an embodiment of a cover in a first orientation.

FIG. 7 is a perspective view of the cover of FIG. 6 in a second orientation.

FIG. 8 is a perspective view of the cover of FIG. 6 on a container in the first orientation.

FIG. 9 is a perspective view of the cover of FIG. 6 on a container in the second orientation.

FIG. 10 shows an embodiment of a container in a stacked configuration.

FIG. 11 shows another embodiment of a container in a stacked configuration.

FIG. 12 shows an embodiment of a plurality of containers in a nested configuration.

FIGS. 13a through 13d show a method of deploying the dividers in the container of FIG. 1.

FIG. 14 is a top view of the container of FIG. 1.

### DETAILED DESCRIPTION OF EMBODIMENTS OF THE INVENTION

The storage system of the invention provides an attractive and sturdy storage system that is flexible and portable and that uses modular organizational components. The system comprises containers that are dimensioned to allow same-size containers to be stacked and smaller size containers to be nested inside of larger size containers. The containers comprise internal flex dividers that can open and close independently such that the internal space of the containers may be reconfigured by the end user to suit their needs. The system also comprises a multi-function cover for the container. The cover may function as a lid for the internal storage compartments that creates an extra layer of storage when placed on the container in a first orientation; as a lid for the container when placed on the container in a second orientation; or as an independent tray.

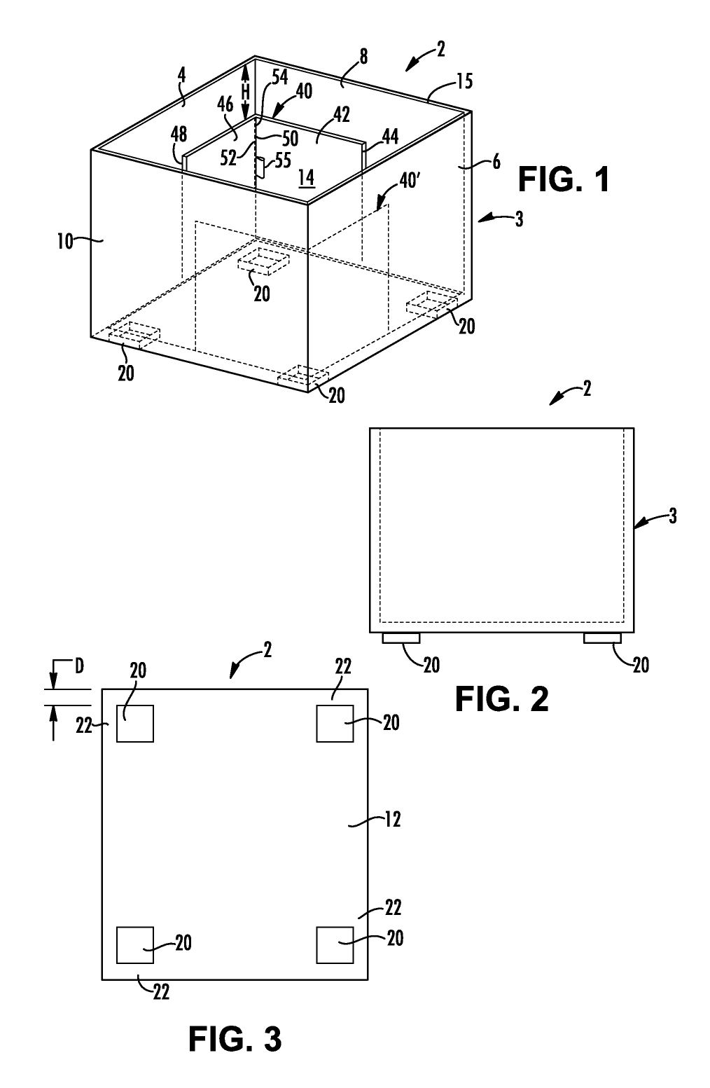

Referring to FIGS. 1 through 3, an example container 2 is shown that comprises a base 12 and a side wall 3 that extends from the base 12 to define an interior space 14. As shown, the container has a cuboid structure having a first opposing parallel pair of side walls 4 and 6, a second opposing parallel pair of side walls 8 and 10 and a rectilinear bottom wall that forms base 12. The top edge of side wall 3 defines an opening 15 to allow access to the interior space 14. The side wall 3 may extend at substantially a right angle relative to base 12. The side wall 3 and base 12 of the container are made of a rigid material such that the containers are self-supporting and may be stacked on top of one another. While the containers are shown as having a cuboid shape, the container may have other shapes. The side wall may be provided with cut out portions 16 that form hand holds that may be grasped by the user to lift and carry the container 2. As shown the hand holds are formed on opposing side walls 8 and 10.

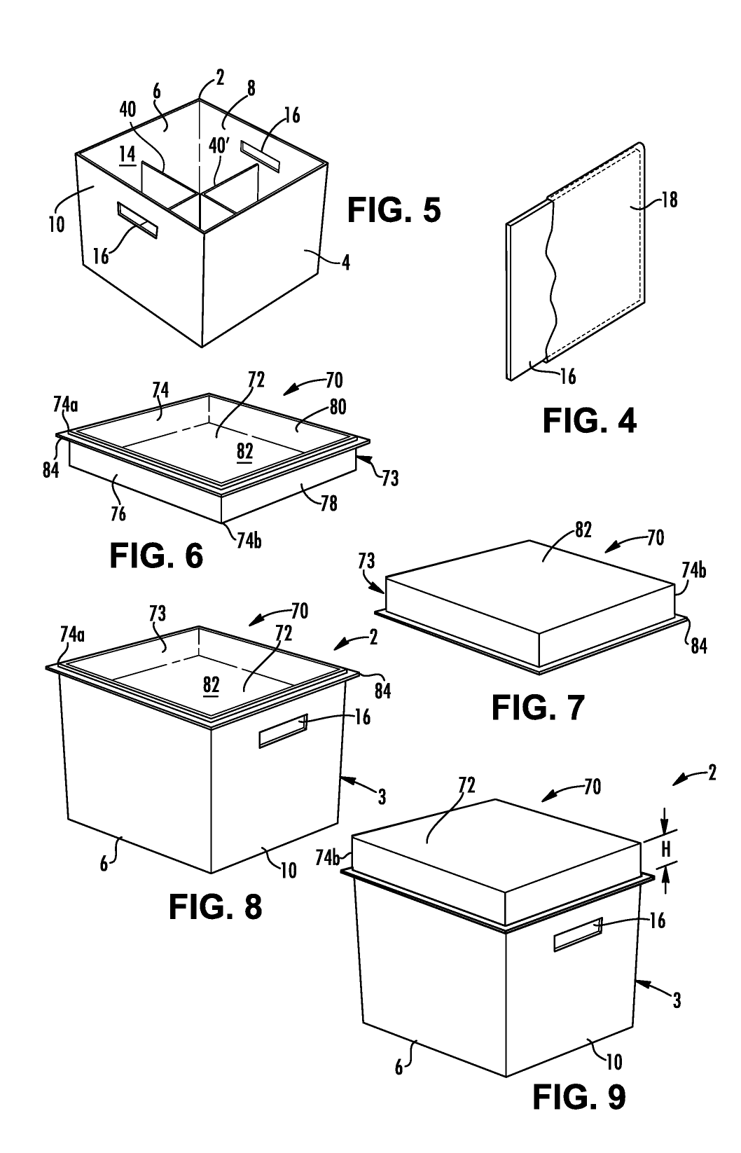

Referring to FIG. 4 in one embodiment the container side wall 3 and base 12 are comprised of a rigid inner panel 16 surrounded by a decorative outer covering 18. In one preferred embodiment the rigid inner panel 16 is made of a rigid material and may comprise medium density fiber board (MDF) or California Air Resources Board (GARB)-certified MDF. The interior panel 16 may also comprise any suitable rigid material or multiple layers of material. The rigid panel 16 may be covered by a decorative outer cover 18 such as fabric such as polyester fabric. Other suitable soft materials may be used for the cover 18. Further, the cover 18 may also comprise a rigid material such as wood, wicker/natural materials, metal, wire or the like. The decorative cover may only be provided on the outside surface of panel 16 if desired.

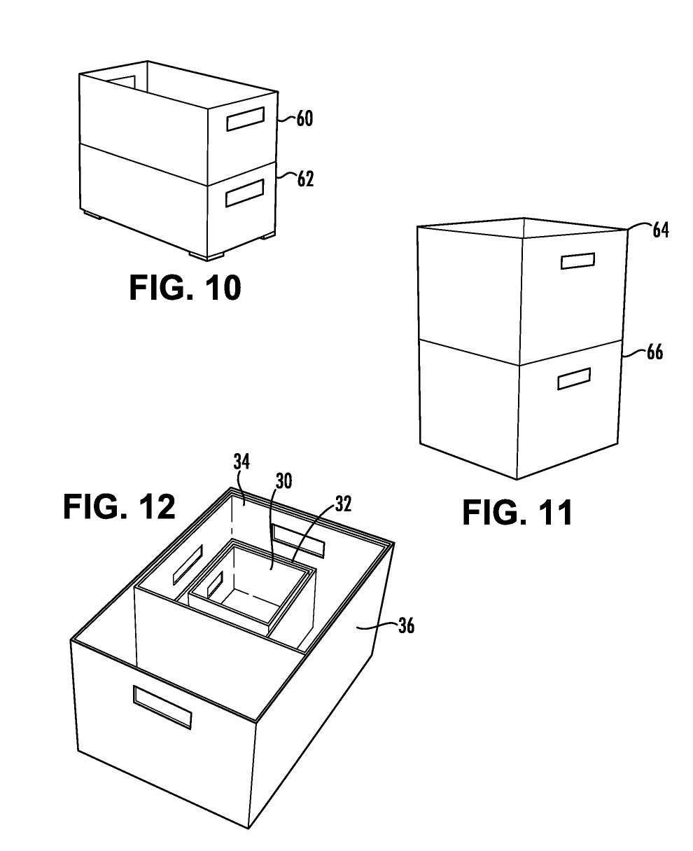

The base 12 of container 2 is provided with base footers 20. The base footers 20 comprise blocks that are secured to the exterior of base 12. The base footers 20 are spaced from the edges of base 12 a distance D approximately equal to the thickness of side wall 3 to create a rim 22 about the periphery of the base 12 between the base footers 20 and the edge of the container 2. The base footers 20 of one container may be inserted into the top opening 15 of another container of the same size with the rim 22 sitting on the top edge of the side wall 3 and the base footers 20 disposed closely adjacent to the side wall 3. FIG. 10 shows a first size rectangular container 60 stacked on top of a second rectangular container 62 of the same size and FIG. 11 shows a second size cube container 64 stacked on top of a second cube container 66 of the same size.

The containers are also dimensioned such that a smaller size container may be nested inside of a larger size container as shown in FIG. 12. FIG. 12 shows a smaller cube container 30 nested inside of a larger rectangular container 32. The rectangular container 32 is nested inside of a larger cube container 34 and the larger cube container 34 is nested inside of a large rectangular container 36.

Referring to FIGS. 1, 5, and 14 at least one movable divider 40 is provided in the container 2. The divider 40 comprises a first wall 42 having a first vertical edge 44 connected to side wall 3 and a second wall 46 having a vertical edge 48 connected to side wall 3. In the illustrated embodiment vertical edge 44 is connected to the first side wall 8 and vertical edge 48 is connected to an adjacent side wall 4. The bottom edges of the first wall 42 and the second wall 46 are disposed closely adjacent base 12 and the top edges of first wall 42 and second wall 46 are spaced a distance H from the top edge of side wall 3. In the illustrated embodiment the length L of wall 42 is approximately one half the length B of side wall 8. As a result, the divider 40, when deployed, extends for approximately one fourth the area of base 12 as shown by dotted line in FIG. 14. Likewise, the length of wall 46 is approximately one half the length of side wall 4. The second vertical edge 50 of wall 42 is connected to the second vertical edge 52 of wall 46 at vertical corner 54 where corner 54 is positioned at the corner between the side walls 4 and 8.

The walls 42 and 46 are made of a resilient, flexible material such as styrene and may be covered by a flexible cover such as polyester fabric. The flexible cover of divider 40 may be the same as the flexible cover 18 used on side wall 3 and base 12. The dividers 40 may occupy a first retracted, stowed position where the walls 42 and 46 are parallel to and adjacent the side wall 3 and a second extended, deployed position where the walls are spaced from side wall 3 to define a storage compartment 41 between the divider 40 and the side wall 3. In the first position the walls 42 and 46 are parallel to side walls 8 and 4 (solid line view of divider 40 in FIG. 14). In the second position the walls 42 and 46 extend substantially perpendicularly from the side walls 8 and 4 to define storage area 41 between the walls 42 and 46 of divider 40 and the side walls 8 and 4 of container 2 (dashed line view of divider 40 in FIG. 14). This construction provides a “pop-in”/“pop-out” function to deploy the dividers. A second flexible divider 40′ may be provided that operates in the same manner as divider 40. In the figures the second divider 40′ is disposed on the diagonal corner of container 2 opposite to divider 40 between side walls 6 and 10 and may be used to divide the container into four separate compartments 41, 43, 45 and 47 as shown in FIGS. 5 and 14. The dividers may be provided on adjacent corners of container 2 and a greater or fewer number of dividers may be provided. The dividers 40 operate independently of one another such that the user may configure the interior space into one, two or four compartments by deploying neither, one or both of the dividers.

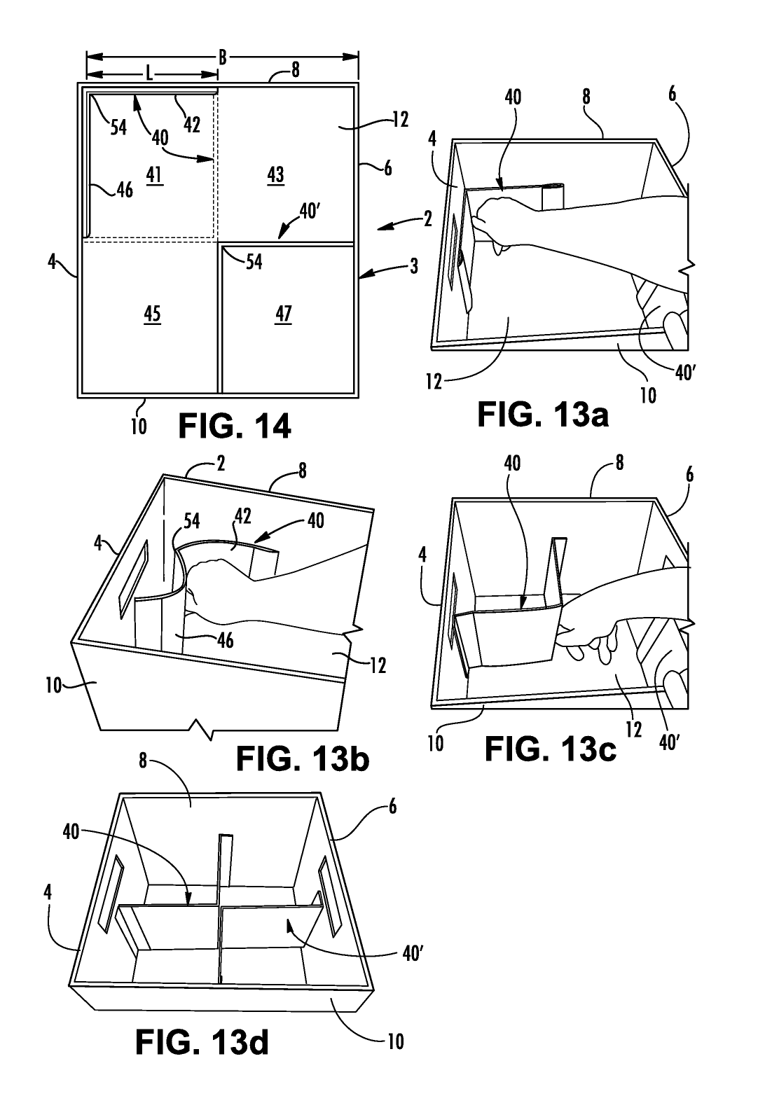

Referring to FIGS. 13a-13d, to move the dividers between the deployed and stowed positions, a user may grasp the divider 40 in the area adjacent corner 54 (FIG. 13a). A pull tab 55 may be provided along corner 54 to allow the user to better grasp the divider. The user pulls the corner 54 away from the side walls of container 2 toward the center of the container. As the corner is pulled one or both of the flexible walls 42 and 44 deform as shown in FIG. 13b. The divider is pulled until the divider reaches the deployed position shown in FIG. 13c. Because the divider walls 42 and 44 are made of a flexible, resilient material the divider will pop into the position of FIG. 13c from the position of FIG. 13b as the deformed side walls flex from the deformed condition to the straight deployed position. In the configuration of FIG. 13c a first compartment 41 is formed between divider and side walls and a second larger compartment 62 defines the remaining area of the internal space. The second divider 40′ may also be deployed to the position of FIG. 13d. In this configuration the corners 54 of the dividers 40, 40′ contact or are closely adjacent to one another at the center of the container because each of the dividers extends for approximately one half of the length of side walls 4, 6, 8 and 10. The dividers divide the interior space into four equal compartments 41, 43, 45 and 47. While the dividers are shown as extending for approximately half the length of the side walls, the dividers may be made longer or shorter than those shown to create compartments of varying sizes. The flexible dividers affixed to the rigid support walls allow for internal organization in a sturdy, stackable system.

Referring to FIGS. 6 through 9 a cover 70 that functions as a combination lid and tray is provided. The cover 70 comprises a base 72 and a side wall 73 that extends from the periphery of base 72 to define an interior space 82. In the illustrated embodiment side wall 73 is defined by four side walls 74, 76, 78 and 80 that extend from a rectilinear base 72 such that the cover defines a cuboid shape that matches the shape of the container 2. A lip 84 extends about the external periphery of the side wall 73 to divide the side wall 73 into an upper section 74a and a lower section 74b. The lip 84 is spaced farther from base 72 than from the distal end of side wall 73 such that upper section 74a is smaller than lower wall section 74b. The base 82 is dimensioned such that the side wall 73 may be fit into the top opening 15 of the container 2 with minimum clearance. The cover 70 may be placed on the container such that the lip 84 engages the top edge of side wall 3. With the cover 70 oriented as shown in FIGS. 6 and 8 the lower side wall section 74b extends into the container 2 with the interior space 82 facing upward to create a cover for items stored in the containers and a storage shelf for retaining items on the top of the base 82. The height H of the cover between the lip 84 and base 72 may be approximately equal to the space between the top edge of the container 2 and the top of dividers 40, 40′ (See FIG. 1) such that base 82 closes the tops of compartments 41, 43, 45 and 47. With the cover 70 oriented as shown in FIGS. 7 and 9 the upper side wall section 74a extends into the container 2 with the interior space 82 facing downward where the cover functions as a lid that closes container 2 and expands the capacity of the container by the height H of the cover between the lip 84 and base 82. The cover 50 may also function as an independent tray separate from containers 2.

While embodiments of the invention are disclosed herein, various changes and modifications can be made without departing from the spirit and scope of the invention as set forth in the claims. One of ordinary skill in the art will recognize that the invention has other applications in other environments. Many embodiments are possible. The following claims are in no way intended to limit the scope of the invention to the specific embodiments described above.

1. A storage system comprising:
a container comprising a rigid side wall defining a corner;
a divider comprising a first flexible wall attached to the side wall and a second wall attached to the side wall, the first wall being connected to the second wall and being movable between a first configuration where the first wall and the second wall extend parallel to the side wall and a second configuration where the first wall and the second wall extend away from the side wall to define a first compartment in the container.

2. The container of claim 1 wherein the side wall comprises a first rigid side wall, a second rigid side wall, a third rigid side wall opposite to the first side wall and a fourth rigid side wall opposite to the second side wall defining an opening.

3. The container of claim 1 wherein the container has a cuboid structure.

4. The container of claim 1 wherein the side wall comprises a rigid panel covered by a decorative outer covering.

5. The container of claim 4 wherein the rigid panel comprises medium density fiber board (MDF).

6. The container of claim 4 wherein the outer cover comprises a polyester fabric.

7. The container of claim 2 further comprising a base connected to the side wall where the base comprises base footers.

8. The container of claim 7 wherein the base footers are spaced from a peripheral edge of the base a distance approximately equal to the thickness of the side wall to create a rim on the base between the base footers and a peripheral edge of the base.

9. The container of claim 8 wherein the base footers of a first container may be inserted into an opening of a second container where the rim rests on the side wall and the base footers are disposed closely adjacent to the side wall.

10. The container of claim 2 wherein the first wall has a first vertical edge connected to the first side wall and the second wall has a second vertical edge connected to the second side wall.

11. The container of claim 10 wherein the length of first wall is one half the length of the first side wall and the length of the second wall is one half the length of the second side wall.

12. The container of claim 10 wherein a second vertical edge of the first wall is connected to a second vertical edge of the second wall at a corner.

13. The container of claim 1 wherein the second wall is flexible.

14. The container of claim 1 further comprising a second divider wherein the divider and the second divider divide the container into four separate compartments.

15. The container of claim 16 wherein the four compartments are approximately of equal size.

16. The container of claim 1 further comprising a lid that defines an interior space where the lid may be placed on the container in a first orientation with the interior space facing away from the container to create a cover for items stored in the container and a shelf for retaining items on the top of the lid.

17. The container of claim 16 where the lid may be placed on the container in a second orientation with the interior space facing toward the container where the lid expands the capacity of the container.

18. A storage system comprising:
a first container comprising a first rigid side wall and a first divider comprising a first flexible resilient wall attached to the first rigid side wall and being movable between a first configuration where the first divider is spaced from the first rigid side wall to create a first storage compartment with the first rigid side wall and a second configuration where the first divider is disposed along and closely adjacent to the first rigid side wall; and
a second container comprising a second rigid side wall and a second divider comprising a second flexible resilient wall attached to the second side wall and being movable between a first configuration where the second divider is spaced from the second rigid side wall to create a second storage compartment with the second rigid side wall and a second configuration where the second divider is disposed along and closely adjacent to the second rigid side wall, wherein the first container is the same size as the second container such that the first container may be supported on the side wall of the second container.

19. The system of claim 18 further comprising a third container a third container comprising a third rigid side wall and a third divider comprising a third flexible resilient wall attached to the third side wall and being movable between a first configuration where the third divider is spaced from the third rigid side wall to create a third storage compartment with the third rigid side wall and a third configuration where the third divider is disposed along and closely adjacent to the third rigid side wall, wherein the third container is smaller than the second container.

20. A method of using a storage system comprising:
providing a container comprising a first side wall and a second side wall defining a first corner and a divider comprising a first flexible wall attached to the first side wall and a second wall attached to the second side wall where the first flexible wall is attached to the second flexible wall at a second corner;
grasping the divider in the area adjacent the second corner;
pulling the second corner away from the first corner to deform at least one of the first flexible wall and the second flexible wall;
allowing the at least one of the first flexible wall and the second flexible wall to return to an undeformed state where the first flexible wall extends away from the first side wall and the second flexible wall extends away from the second side wall.
